(19) United States
(12) Patent Application Publication
(10) Pub. No.: US 2025/0328214 A1
(43) Pub. Date: Oct. 23, 2025

(54) APPLIANCE AND CAMERA BASED USER INTERFACE

(71) Applicant: Haier US Appliance Solutions, Inc., Wilmington, DE (US)

(72) Inventor: Vineeth Vijayan, Louisville, KY (US)

(21) Appl. No.: 18/641,563

(22) Filed: Apr. 22, 2024

(51) Int. Cl. G06F 3/04815; G06F 3/0484

(52) U.S. Cl. CPC G06F 3/04815; G06F 3/0484

(57) ABSTRACT

An appliance, a computing device therefor, and a method for operating an appliance include generating a virtual user interface corresponding to a surface of the appliance within a field of view of an imaging device operably coupled to an appliance computing device. The virtual user interface includes a digital marker corresponding to an appliance control function. The method includes generating a control signal based on a physical user interaction relative to the digital marker, and transmitting the control signal to articulate an operational component of the appliance corresponding to the appliance control function.

### FIELD OF THE INVENTION

The present disclosure is related generally to appliances and methods for operating an appliance.

### BACKGROUND OF THE INVENTION

Appliances generally include user control interfaces electrically coupled to an appliance controller and fixed into surface of the appliance, such as a cabinet or door. User control interfaces generally include wires that route through the appliance to the user control interface, such as to provide energy for operation and to transmit and receive control signals. User control interfaces generally include buttons, knobs, switches, haptic feedback devices, touchscreens, or other electrical or mechanical user input interfaces. The user input interfaces are communicatively coupled to the appliance controller to transmit and receive signals for operating components at the appliance.

Additionally, user control interfaces may require insulation and seals to protect the user control interface and associated electrical couplings from various environmental conditions, such as moisture, heat, or cold. Accordingly, appliances may require space, volume, and interfaces for accommodating insulation, seals, and protective structures at the user control interface, which may add cost and complexity to the appliance, and limit potential places at which the user control interface may be positioned.

Additionally, or alternatively, electrical couplings and electrical or mechanical user input interfaces may be prone to degradation and deterioration through repeated usage, which may limit appliance functionality or require costly repair or replacement.

As such, there is a need for improved user control interfaces that address one or more of the aforementioned issues.

### BRIEF DESCRIPTION OF THE INVENTION

Aspects and advantages of the invention will be set forth in part in the following description, or may be apparent from the description, or may be learned through practice of the invention.

An aspect of the present disclosure is directed to an appliance computing device including a processor operably coupled to an imaging device. The processor is configured to execute instructions that cause operations. The operations include generating a virtual user interface relative to a surface within a field of view of the imaging device. The virtual user interface includes a digital marker corresponding to an appliance control function. The operations further include generating a control signal based on a physical user interaction relative to the digital marker.

An aspect of the present disclosure is directed to a method for operating an appliance. The method includes generating a virtual user interface corresponding to a surface of the appliance within a field of view of an imaging device operably coupled to an appliance computing device, the virtual user interface including a digital marker corresponding to an appliance control function; generating a control signal based on a physical user interaction relative to the digital marker; and transmitting the control signal to articulate an operational component of the appliance, wherein articulation of the operational component corresponds to the appliance control function.

An aspect of the present disclosure is directed to an appliance. The appliance includes a surface, an operational component configured to perform a control function, an imaging device configured with a field of view toward the surface, and a computing device including a processor operably coupled to the imaging device. The processor is configured to execute operations, the operations including generating a virtual user interface corresponding to the surface within the field of view of the imaging device, the virtual user interface including a digital marker corresponding to the control function; generating a control signal based on a physical user interaction relative to the digital marker; and transmitting the control signal to perform the control function at the operational component.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a refrigerator appliance according to an exemplary embodiment of the present subject matter with doors of the example refrigerator appliance shown closed.

FIG. 2 is a perspective view of the exemplary refrigerator appliance with doors shown open.

FIG. 3 is a schematic view of an appliance and computing device in accordance with aspects of the present disclosure.

FIG. 4 provides a flowchart outlining steps of a method for operating an appliance in accordance with aspects of the present disclosure.

FIG. 5 is a perspective view of an exemplary appliance in accordance with aspects of the present disclosure.

FIG. 6 is a perspective view of an exemplary appliance in accordance with aspects of the present disclosure.

FIG. 7 is a perspective view of an exemplary appliance in accordance with aspects of the present disclosure.

FIG. 8 is a perspective view of an exemplary appliance in accordance with aspects of the present disclosure.

FIG. 9 is a front view of an exemplary appliance in accordance with aspects of the present disclosure.

FIG. 10 is a front view of an exemplary appliance in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Embodiments of a refrigerator appliance, a computing device, and a method for operating an appliance are provided that may address one or more of the aforementioned issues. Embodiments of the appliance include an imaging device, such as a camera, positioned with a field of view at a surface, such as a surface of the appliance, and a computing device configured to execute instructions that cause the appliance to perform operations. The operations generate a virtual user interface at or proximate to the surface within the field of view of the imaging device. Control signals are generated based on physical user interaction at the virtual user interface.

Embodiments provided herein may allow for development and positioning of user control interfaces electrically uncoupled from physical user interfaces that generally include wired connections for power supply and/or electronic communication, and/or knobs, switches, buttons, or other physical interfaces that may be electrically or mechanically coupled to a controller. Electrical uncoupling of the physical user interface from the controller may allow for enhanced aesthetic designs and placement of user control interfaces at various surfaces. The virtual user interface may remove a need for electronic control boards, physical interfaces, wires, and sensors as may generally be associated with physical user control interfaces, which may further reduce cost and complexity, remove a need for insulation and seals associated with user interfaces, and improve durability and longevity by removing degradable components.

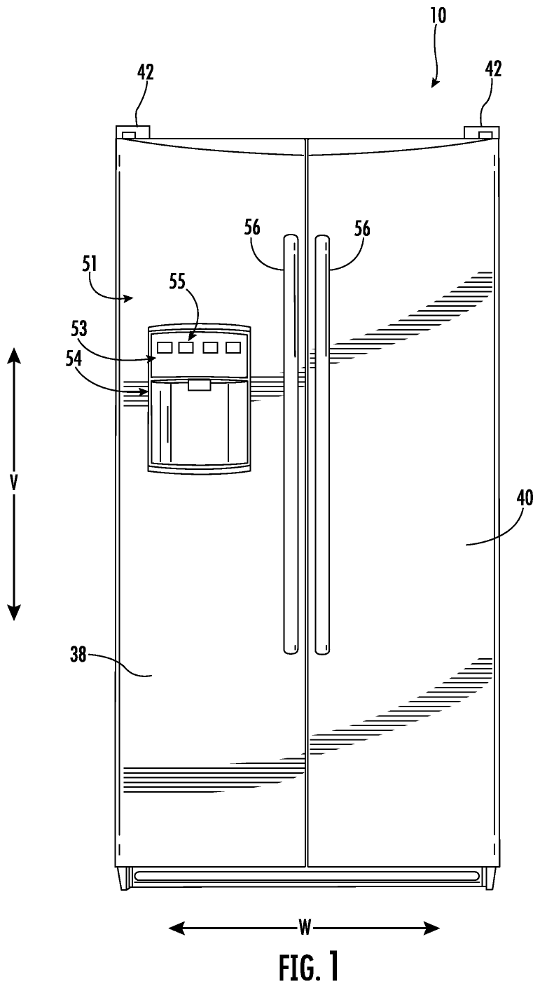

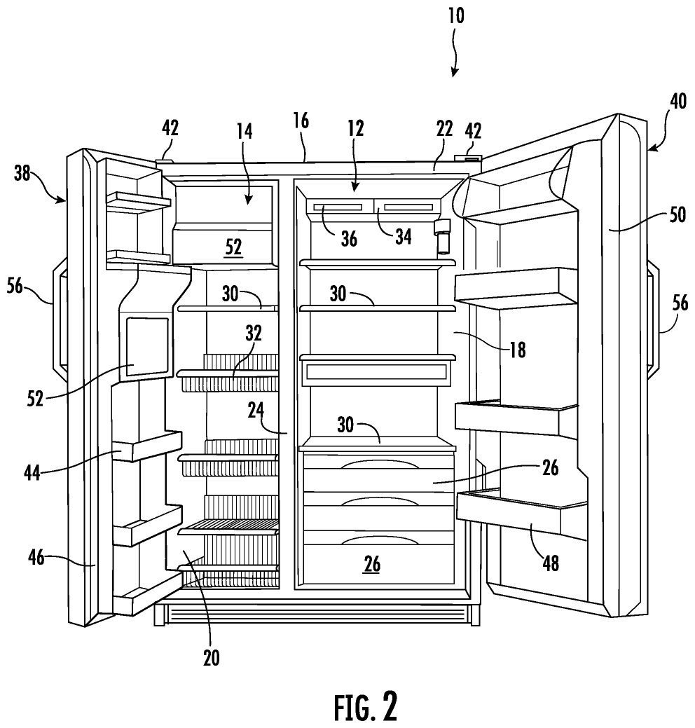

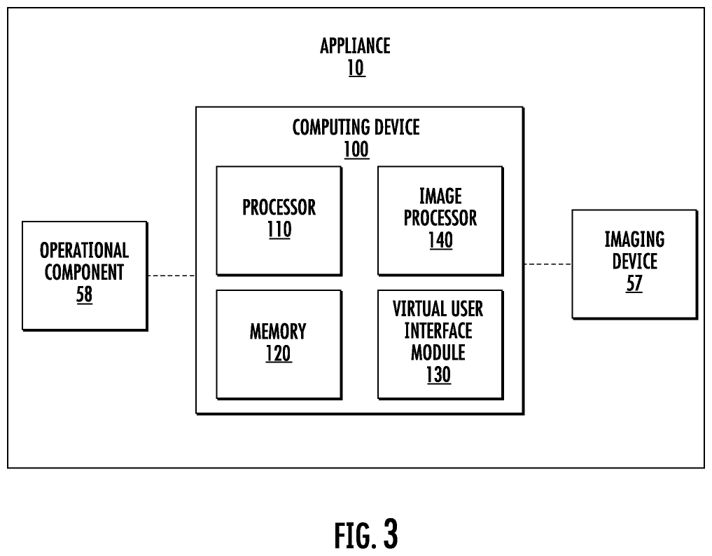

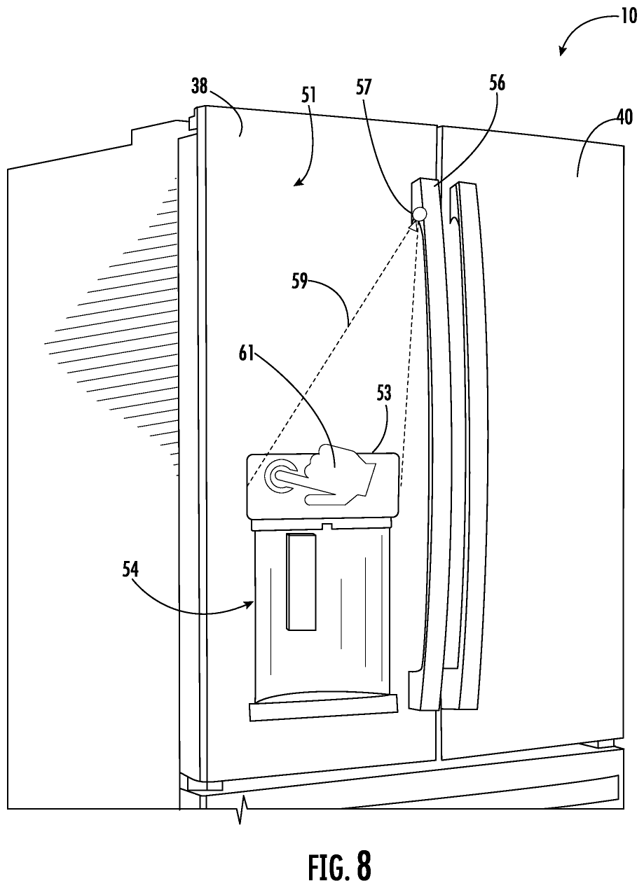

FIGS. 1-8 depict an appliance 10 according to an exemplary embodiment of the present subject matter. FIGS. 1-2 depict the appliance 10 as a refrigerator appliance. However, referring to FIGS. 3-8, it should be appreciated that appliance 10, and appliance controllers and methods further described herein, may include appliances generally including an interior or exterior surface 51 physically accessible to a user, an operational component 58 configured to perform a control function, an imaging device 57 configured with a field of view 59 toward the surface 51, and a computing device 100 operably coupled to the imaging device 57 and the operational component 58. For instance, the operational component 58 can include dispensers (e.g., water and/or ice dispenser), motors, actuators, heating and/or cooling apparatuses (e.g., heating elements, heat exchangers, etc.), microwave devices, washer and/or dryer devices, or other assemblies and components generally associated with household or commercial appliances. Control functions can include dispensing a fluid or ice, generating or removing heat, performing a cleaning, washing, or drying cycle, or other function generally associated with household or commercial appliances.

FIG. 1 provides an exemplary perspective view of the appliance 10 configured as a side-by-side refrigerator appliance including a refrigeration chamber and a freezer chamber. FIG. 2 provides a perspective view of the appliance 10 of FIG. 1 with doors 38, 40 open to view refrigeration and freezer compartments 12, 14 formed within a cabinet or outer case 16. FIG. 1 provides a reference vertical direction V and width direction W.

Referring to FIG. 2, appliance 10 includes the refrigeration compartment 12 and the freezer compartment 14, with the compartments arranged side-by-side and contained within the outer case 16. Outer case 16 and inner liners 18 and 20 are generally molded from a suitable plastic or foam material. For instance, the outer case may form a molded plastic or foam outer case. Thus, appliance 10 is generally referred to as a side-by-side style refrigerator appliance. In alternative exemplary embodiments, appliance 10 may include a single liner and a mullion that spans between opposite sides of the single liner to divide it into the freezer compartment 14, such as a compartment configured for frozen foods, and the refrigeration compartment 12, such as a compartment configured for fresh foods. Outer case 16 is normally formed by folding a sheet of a suitable material, such as pre-painted steel, into an inverted U-shape to form top and side walls of outer case 16. A bottom wall of outer case 16 normally is formed separately and attached to the case side walls and to a bottom frame that provides support for appliance 10. However, it should be appreciated that outer case 16 may be formed by other suitable manufacturing methods.

A breaker strip 22 extends between a case front flange and outer front edges of inner liners 18 and 20. Breaker strip 22 is formed from a suitable resilient material, such as an extruded acrylo-butadiene-styrene based material (commonly referred to as ABS). The insulation in the space between inner liners 18 and 20 is covered by another strip of suitable resilient material, which also commonly is referred to as a mullion 24 and may be formed of an extruded ABS material. Breaker strip 22 and mullion 24 may form a front face, and extend completely around inner peripheral edges of outer case 16 and vertically between inner liners 18 and 20.

Slide-out drawers 26 and shelves 30 are normally provided in refrigeration compartment 12 to support items being stored therein. In addition, a shelf 30, a basket 32, or both, are generally provided in freezer compartment 14.

Referring to FIGS. 1-2, a freezer door 38 and a fresh food door 40 close access openings to freezer compartment 14 and refrigeration compartment 12. Freezer door and fresh food door 38 and 40 are each mounted by a top hinge 42 and a bottom hinge (not shown) to rotate about its outer vertical edge between an open position, as shown in FIG. 1, and a closed position. Freezer door 38 may include a plurality of storage shelves 44 and a sealing gasket 46, and fresh food door 40 also includes a plurality of storage shelves 48 and a sealing gasket 50.

Freezer compartment 14 may include an automatic ice maker 52 and a dispenser assembly 54 provided in freezer door 38 such that ice and/or chilled water can be dispensed without opening freezer door 38, as is well known in the art. Freezer door and fresh food door 38 and 40 may be opened by handles 56. It should be appreciated that the dispenser assembly 54 may be positioned at an exterior portion of the door, such as depicted in FIG. 1, or positioned in an interior portion, such as to require opening the door to access the dispenser assembly 54.

Appliance 10 also includes a machinery compartment (not shown) that includes one or more operational components. For instance, the machinery compartment may at least partially contain a cooling system including components for executing a known vapor compression cycle for cooling air. The cooling system may include a compressor, a condenser, an expansion device, and an evaporator connected in series as a loop and charged with a refrigerant. The evaporator is a type of heat exchanger which transfers heat from air passing over the evaporator to the refrigerant flowing through the evaporator, thereby causing the refrigerant to vaporize. The cooled air is used to refrigerate one or more refrigerator or freezer compartments via fans. Also, a cooling loop can be added to direct cool the ice maker to form ice cubes, and a heating loop can be added to help remove ice from the ice maker. Collectively, the vapor compression cycle components in a refrigeration circuit, associated fans, and associated compartments are conventionally referred to as a sealed system. The construction and operation of the sealed system are well known to those skilled in the art.

Although the appliance 10 of FIGS. 1-2 is depicted and described as a side-by-side refrigerator appliance, it should be appreciated that present disclosure may apply to other refrigerator appliance configurations, such as, but not limited to, top-bottom configurations, two-compartment configurations, three-compartment compartment configurations, dispenser assembly within the cabinet, refrigerator-only configuration, freezer-only configuration, etc. Furthermore, as provided herein, appliance 10 may be configured as other commercial or household appliances, such as, but not limited to, stovetop or oven cooking appliances, microwave appliances, dishwasher appliances, laundry appliances, etc.

Referring now to FIG. 3, a schematic view of an exemplary embodiment of appliance 10 is provided. Appliance 10 includes a computing device 100 configured to receive or store instructions that, when executed, cause the appliance 10, or operational components 58 thereof, to perform operations. In various embodiments, appliance 10 features are regulated with computing device 100. Input/output (“I/O”) signals may be routed between computing device 100 and various operational components 58 of appliance 10. The operational components 58 may be in communication with computing device 100 via one or more wired or wireless signal lines or shared communication busses.

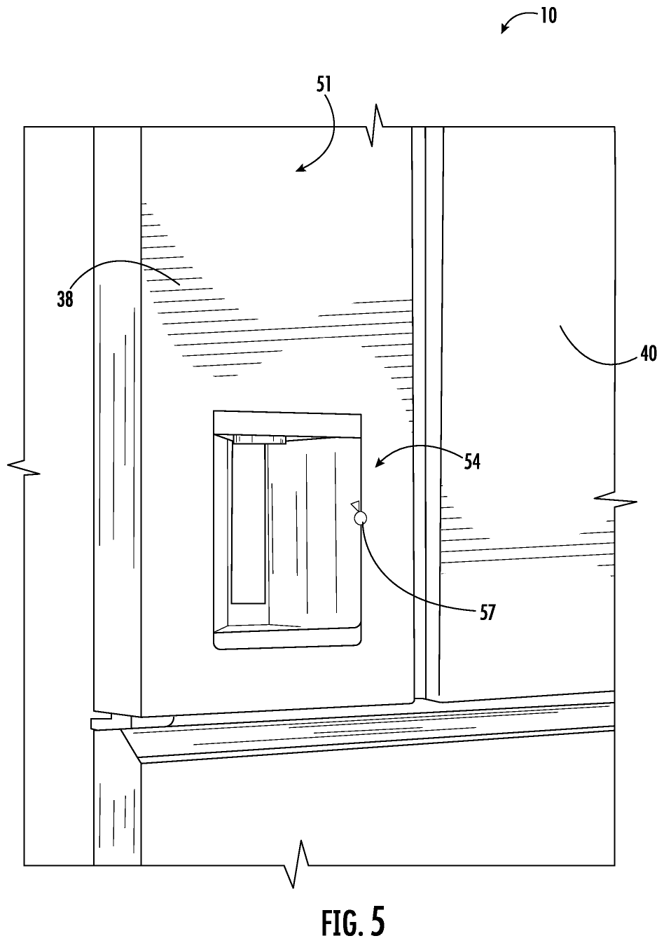

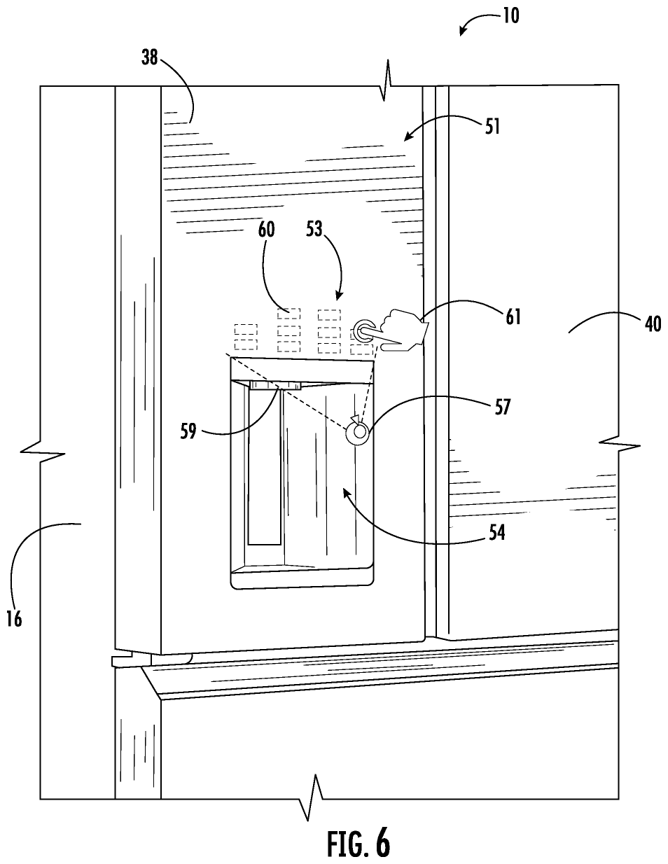

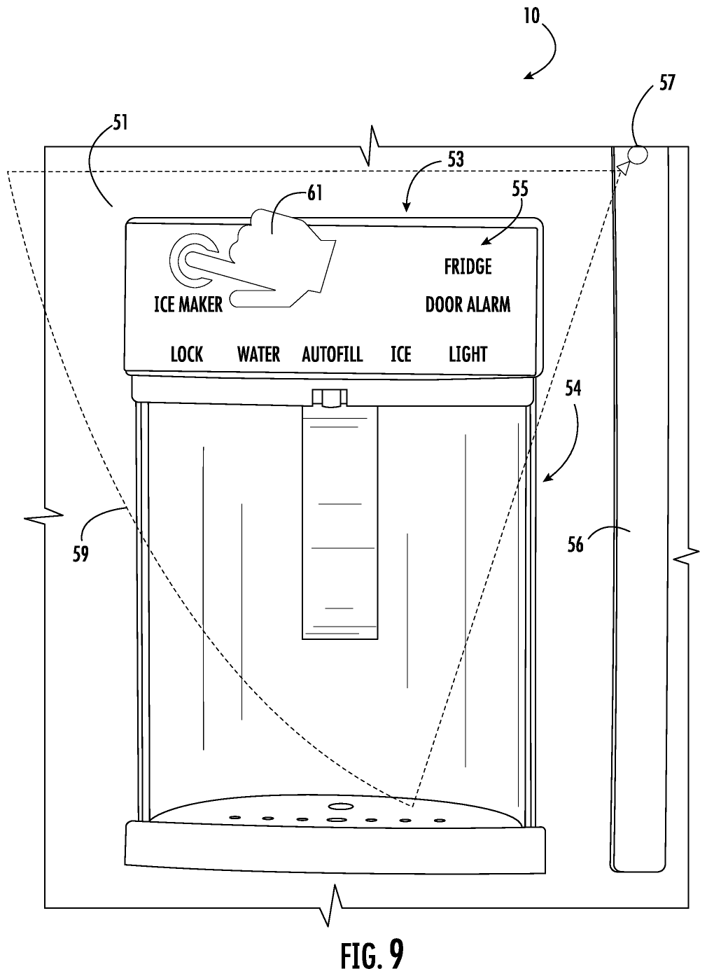

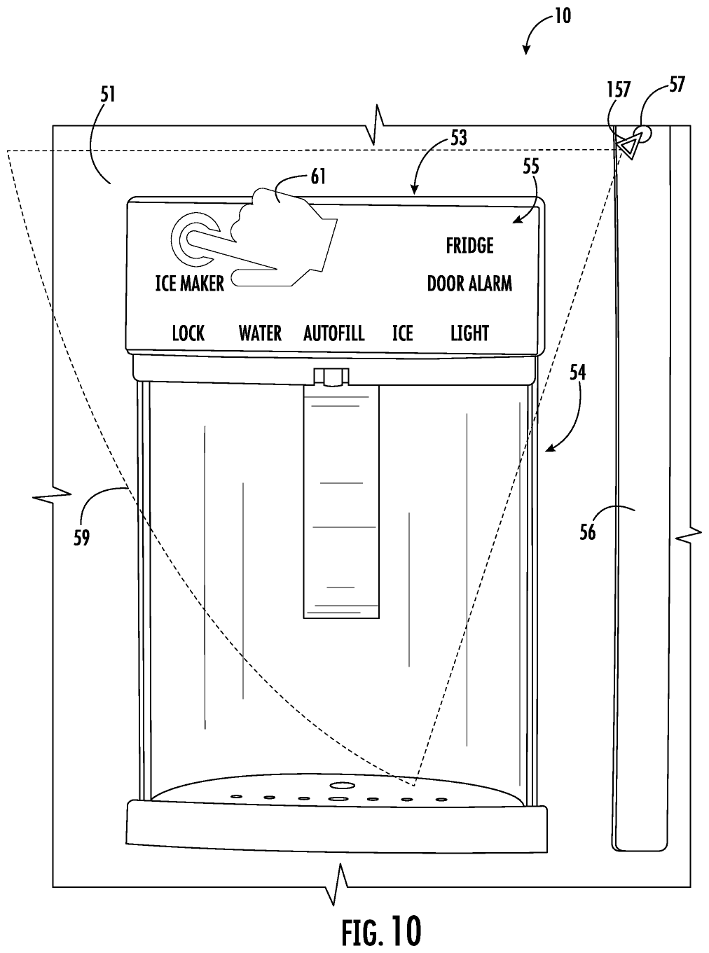

Imaging device 57 is configured with a field of view toward a surface (such as field of view 59 toward surface 51 depicted schematically in FIGS. 6-10). Imaging device 57 is communicatively coupled to computing device 100 to transmit images obtained by imaging device 57. In various embodiments, imaging device 57 includes a camera or other device configured to generate an electronic or digital image within the field of view. In some embodiments, such as depicted in FIGS. 5-8, imaging device 57 may be positioned at dispenser assembly 54. In still some embodiments, such as depicted in FIG. 9-10, imaging device 57 may be positioned at handle 56.

Computing device 100 can include any device that includes one or more processors 110 and memory 120. As an example, in some embodiments, computing device 100 may be a single board computer (SBC). For example, computing device 100 can be a single System-On-Chip (SOC). However, any form of computing device 100 may also be used to perform the present subject matter. The processor(s) 110 can be any suitable processing device, such as a microprocessor, microcontroller, integrated circuit, or other suitable processing devices or combinations thereof. The memory 120 can include any suitable storage media, including, but not limited to, non-transitory computer-readable media, RAM, ROM, hard drives, flash drives, accessible databases, or other memory devices. The memory 120 can store information accessible by processor(s) 110, including instructions that can be executed by processor(s) 110 to perform aspects of the present disclosure, such as steps of method 1000 provided herein.

The computing device 100 includes a virtual user interface module 130 configured to generate a digital marker corresponding to an appliance control function. For instance, an appliance 10 including an operational component 58 corresponding to a dispenser assembly 54 may include a first appliance control function corresponding to activating dispensing water is electronically coupled to a first digital marker; a second appliance control function corresponding to activating or deactivating a light is electronically coupled to a second digital marker; a third appliance control function corresponding to dispensing ice is electronically coupled to a third digital marker, etc.

In some embodiments, computing device 100 further includes an image processor 140. Image processor 140 may include any suitable processing device, and may further be configured for performing image processing tasks. For instance, image processor 140 include a segmentation routine configured to partition the image captured by imaging device 57 into one or more parts or objects. The image processor 140 may include a representation routine configured to determine regions, boundaries, or features at the image. The image processor 140 may include a recognition or interpretation routine configured to determine an overlay of a digital representation of physical user interaction (depicted schematically by hand 61 in FIGS. 5-8) at the surface 51 to one or more digital markers.

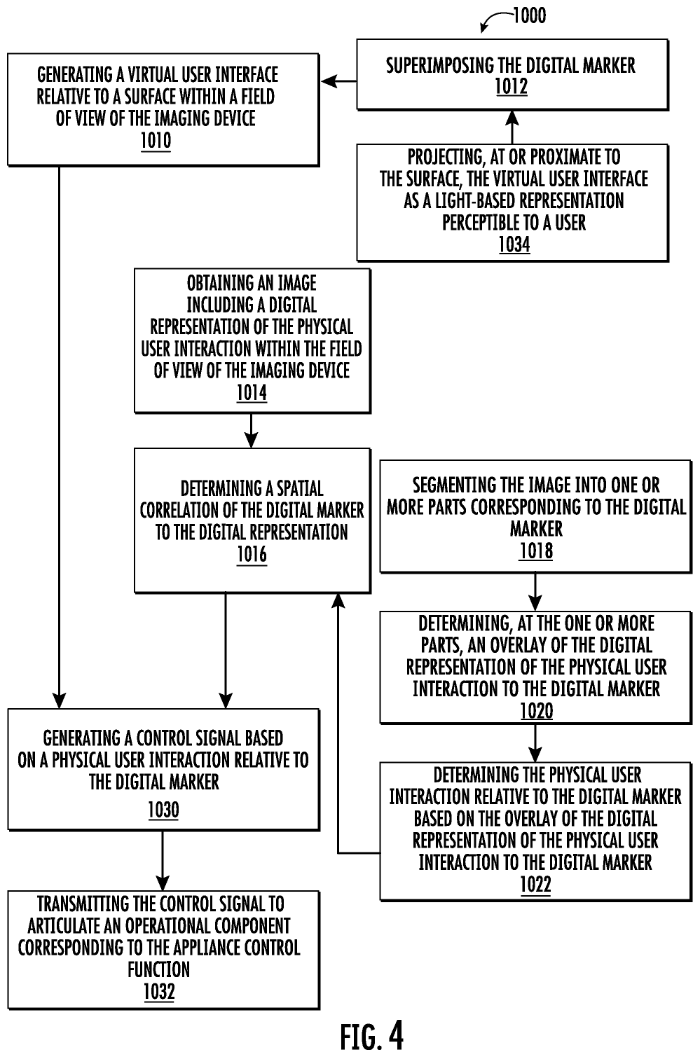

Referring now to FIG. 4, a flowchart outlining steps of a method for operating an appliance is provided (hereinafter, “method 1000”). Steps of method 1000 may generate a virtual user interface at or proximate to a surface (e.g., surface 51), such as may remove a need for a physical user control interface. Steps of method 1000 may be stored as instructions at a computing device. For instance, one or more steps of method 1000 may be stored at memory 120 of computing device 100 and executed by one or more processors 110, 140 and modules 130.

Method 1000 includes at 1010 generating a virtual user interface relative to a surface within a field of view of the imaging device. The virtual user interface includes a digital marker corresponding to an appliance control function. Generating the virtual user interface relative to the surface may include obtaining, from imaging device 57, an image of the surface 51 upon which the virtual user interface is virtually superimposed. In some embodiments, method 1000 at 1010 is performed after a user is detected in proximity to the appliance, such as when the user (e.g., hand 61) extends within the field of view 59. In still some embodiments, user proximity may be detected through a proximity sensor, or opening/closing of one or more doors (e.g., doors 38, 40). Selective activation of the virtual user interface 53, such as based on user proximity within the field of view 59, may reduce energy consumption in contrast to physical user control interfaces.

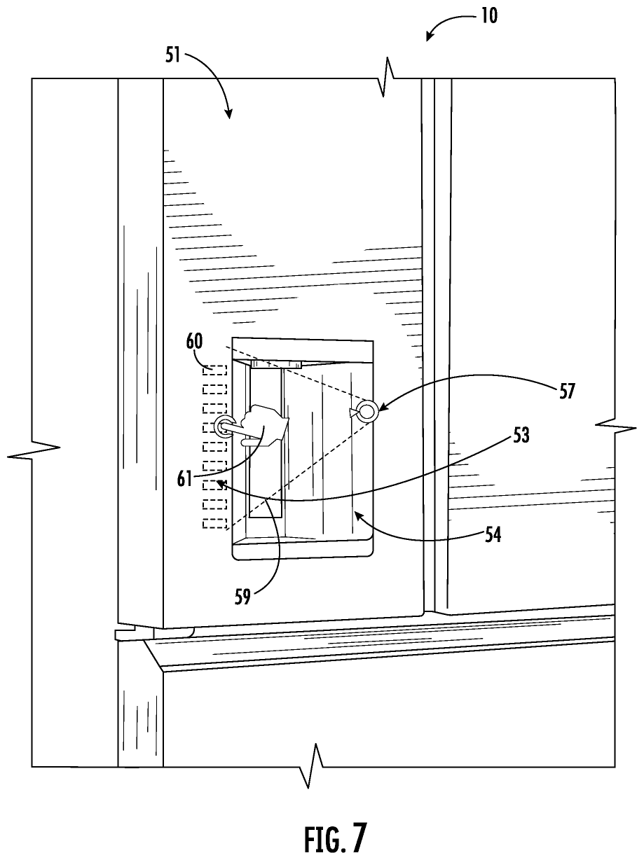

Referring to FIGS. 5-7, perspective views of an exemplary embodiment of appliance 10 configured as a refrigerator appliance are provided. Appliance 10 includes surface 51 at door 38, 40. Dispenser assembly 54 is positioned at door 38. As described herein, surface 51 may be free of physical user control interfaces. Imaging device 57 is positioned with a field of view 59 toward the surface 51. FIGS. 6-7 depict the appliance 10 of FIG. 5 having a virtual user interface 53 virtually superimposed at or proximate to the surface 51, such as in accordance with method 1000. The virtual user interface 53 includes a digital marker, depicted schematically at digital marker 60.

In some embodiments, method 1000 includes at 1012 superimposing the digital marker relative to the surface. Superimposing the digital marker relative to the surface 51 may include obtaining an image, such as via imaging device 57, including a digital representation of the surface 51 within the field of view 59. Digital markers 60 are imposed onto the image and correlated to the surface 51, such as to form the virtual user interface 53. Physical user interaction, such as hand 61, at the surface 51 captured by imaging device 57 and formed into the digital representation is spatially correlated to digital markers 60 forming the virtual user interface 53. It should be appreciated that physical user interaction, although depicted as a hand, may include an object generally, such as, but not limited to, a stylus, a pen, a utensil, etc. In various embodiments, superimposition of the digital marker at or proximate relative to the surface is a virtual superimposition of the digital marker, such as superimposition of the digital marker at or proximate to a digital representation of the surface.

Method 1000 may include at 1014 obtaining an image including a digital representation of the physical user interaction within the field of view of the imaging device. Method 1000 may include at 1016 determining a spatial correlation of the digital marker to the digital representation.

In some embodiments, method 1000 includes at 1018 segmenting the image into one or more parts corresponding to the digital marker, and at 1020 determining, at the one or more parts, an overlay of the digital representation of the physical user interaction to the digital marker. Method 1000 may include at 1022 determining the physical user interaction relative to the digital marker based on the overlay of the digital representation of the physical user interaction to the digital marker.

For instance, referring to FIGS. 4-10, one or more of processor 110, 140 may be configured to determine the spatial correlation of the digital marker to the digital representation. For instance, the image may be segmented based on the digital markers 60. Segmenting the image may include segmenting corresponding to digital markers, such as may isolate whether the physical user interaction at the surface 51 corresponds to a first, second, third, etc. digital marker 60.

Determining an overlay of the digital representation of the physical user interaction, such as hand 61, to the digital marker 60 may be utilized determine whether the user articulated a first, second, third, etc. digital marker 60 to perform a corresponding appliance control function. For instance, relative to the prior example, determining overlay of the digital representation of the physical user interaction (e.g., hand 61) to a first digital marker 60 may generate a first control signal corresponding to a first appliance control function (e.g., dispensing water). Determining overlay of the hand 61 to a second digital marker 60 may generate a second control signal corresponding to a second appliance control function (e.g., activating or deactivating a light). Determining overlay of the hand 61 to a third digital marker 60 may generate a third control signal corresponding to a third appliance control function (e.g., dispensing ice), etc.

Method 1000 includes at 1030 generating a control signal based on a physical user interaction relative to the digital marker. Referring to FIGS. 6-10, physical user interaction, such as depicted via hand 61 of a user, at or proximate to surface 51 corresponding to a virtual location of the superimposed digital marker 60 generates the control signal corresponding to the appliance control function, such as described above.

In some embodiments, method 1000 includes at 1032 transmitting the control signal to articulate an operational component corresponding to the appliance control function. For instance, appliance computing device 100 is communicatively coupled to operational component 58 to transmit the control signal to the operational component 58 to perform the appliance control function, such as described herein.

Referring to FIGS. 9-10, in some embodiments, appliance 10 may include a physical marker 55 positioned at the surface 51. The physical marker 55 includes an etching, writing, groove, bump, raised surface, badge, or other physical feature visually perceptible or tactilely perceptible by a user. The physical marker 55 is electrically uncoupled from appliance computing device 100. For instance, the physical marker 55 is unwired, such as being uncoupled to a power supply, or electric or electronic device, or generally having no physical operable connection.

Referring to FIG. 4, in some embodiments, method 1000 at 1012 may include superimposing the digital marker to the physical marker at the surface. For instance, referring to FIGS. 9-10, method 1000 at 1012 may superimpose the digital marker 60 substantially to physical marker 55. Physical marker 55 may include a visual communication (e.g., writing, symbol, pictograph, etc.) corresponding to an appliance control function. As noted above, the physical marker 55 is physically uncoupled to the appliance computing device 100. However, physical user interaction (e.g., hand 61) at the digital marker 60 virtually superimposed to the physical marker 55 generates the control signal corresponding to the appliance control function and visual communication of the physical marker 55.

It should be appreciated that, in various embodiments, generation of the virtual user interface and virtual superimposition of the digital marker may be performed without requiring physical representation or projection visibly perceptible to the user. For instance, in some embodiments, visible perceptibility by the user of the user interface may be limited to the electrically uncoupled physical marker 55 or surface 51, and the virtual user interface and digital markers may be visually imperceptible by the user. However, in still some embodiments, such as described herein, the virtual user interface may be visually superimposed onto the surface 51.

Referring to FIG. 10, in an embodiment, imaging device 57 further includes a projection device 157 configured to project a light-based representation or image perceptible by a user. Referring to FIG. 4, in some embodiments, method 1000 includes at 1034 projecting, toward the surface, the virtual user interface as a light-based representation perceptible to a user. For instance, method 1000 at 1034 may include projecting a visual representation of the virtual user interface 53 or digital markers 60 onto the surface 51. The projected visual representation may generate a physical representation or marker at which the user may touch at, or proximate to, the surface 51 to generate a control signal such as described herein. For instance, projection device 157 may provide a light-based representation of the digital marker of the virtual user interface superimposed at or proximate to the surface 51.

In still some embodiments, imaging device 57, projection device 157, or both, may include a light source configured to articulate toward the surface 51. For instance, the light source may facilitate acquisition of images of the surface 51 or physical user interaction (e.g., hand 61).

Embodiments of the appliance 10, computing device 100, and method 1000 provided herein may allow for development and positioning of user control interfaces electrically uncoupled from physical user interfaces. Electrical uncoupling of the physical user interface may allow for enhanced aesthetic designs and placement of user control interfaces at various surfaces, remove components that may degrade or deteriorate, or remove a need for electronic control boards, physical interfaces, wires, sensors, insulation, or seals as may generally be associated with physical user control interfaces. Electrical uncoupling of the user control interface may improve durability and longevity by removing degradable components, improve design versatility, and provide replacement interfaces customizable controls without requiring physical hardware installation or changes.

Further aspects of the disclosure are provided in one or more of the following clauses:

1. An appliance computing device including a processor operably coupled to an imaging device, the processor configured to execute instructions that cause operations, the operations including generating a virtual user interface relative to a surface within a field of view of the imaging device, the virtual user interface including a digital marker corresponding to an appliance control function; generating a control signal based on a physical user interaction relative to the digital marker.

2. The appliance computing device of any one or more clauses herein, the operations including obtaining an image including a digital representation of the physical user interaction within the field of view of the imaging device; and determining a spatial correlation of the digital marker to the digital representation.

3. The appliance computing device of any one or more clauses herein, wherein determining the spatial correlation of the digital marker to the digital representation includes segmenting the image into one or more parts corresponding to the digital marker; and determining, at the one or more parts, an overlay of the digital representation of the physical user interaction to the digital marker.

4. The appliance computing device of any one or more clauses herein, the operations including determining the physical user interaction relative to the digital marker based on the overlay of the digital representation of the physical user interaction to the digital marker.

5. The appliance computing device of any one or more clauses herein, the operations including superimposing the digital marker relative to the surface.

6. The appliance computing device of any one or more clauses herein, wherein the control signal corresponds to the appliance control function.

7. The appliance computing device of any one or more clauses herein, the operations including transmitting the control signal to articulate an operational component corresponding to the appliance control function.

8. The appliance computing device of any one or more clauses herein, the operations including projecting, toward the surface, the virtual user interface as a light-based representation perceptible to a user.

9. A method for operating an appliance, the method including generating a virtual user interface corresponding to a surface of the appliance within a field of view of an imaging device operably coupled to an appliance computing device, the virtual user interface including a digital marker corresponding to an appliance control function; generating a control signal based on a physical user interaction relative to the digital marker; and transmitting the control signal to articulate an operational component of the appliance, wherein articulation of the operational component corresponds to the appliance control function.

10. The method of any one or more clauses herein, the method including obtaining, via the imaging device, an image including a digital representation of the physical user interaction within the field of view; and determining a spatial correlation of the digital marker to the digital representation.

11. The method of any one or more clauses herein, wherein determining the spatial correlation of the digital marker to the digital representation includes segmenting the image into one or more parts corresponding to the digital marker; and determining, at the one or more parts, an overlay of the digital representation of the physical user interaction to the digital marker.

12. The method of any one or more clauses herein, the method including determining the physical user interaction relative to the digital marker based on the overlay of the digital representation of the physical user interaction to the digital marker.

13. The method of any one or more clauses herein, the method including superimposing the digital marker relative to the surface.

14. The method of any one or more clauses herein, the method including projecting, toward the surface, the virtual user interface as a light-based representation perceptible to a user.

15. An appliance, including a surface; an operational component configured to perform a control function; an imaging device configured with a field of view toward the surface; and a computing device including a processor operably coupled to the imaging device, the processor configured to execute operations, the operations including generating a virtual user interface corresponding to the surface within the field of view of the imaging device, the virtual user interface including a digital marker corresponding to the control function; generating a control signal based on a physical user interaction relative to the digital marker; and transmitting the control signal to perform the control function at the operational component.

16. The appliance of any one or more clauses herein, wherein the surface includes a physical marker, and wherein the physical marker is uncoupled electrically to the computing device, and wherein the operations include superimposing the digital marker to the physical marker at the surface.

17. The appliance of any one or more clauses herein, the operations including obtaining, via the imaging device, an image including a digital representation of the physical user interaction within the field of view of the imaging device; and determining a spatial correlation of the digital marker to the digital representation.

18. The appliance of any one or more clauses herein, wherein determining the spatial correlation of the digital marker to the digital representation includes segmenting the image into one or more parts corresponding to the digital marker; and determining, at the one or more parts, an overlay of the digital representation of the physical user interaction to the digital marker.

19. The appliance of any one or more clauses herein, the operations including determining the physical user interaction relative to the digital marker based on the overlay of the digital representation of the physical user interaction to the digital marker.

20. The appliance of any one or more clauses herein, wherein determining the spatial correlation of the digital marker to the digital representation includes segmenting the image into one or more parts corresponding to the digital marker; and determining, at the one or more parts, an overlay of the digital representation of the physical user interaction to the digital marker and a physical marker at the surface.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance computing device comprising a processor operably coupled to an imaging device, the processor configured to execute instructions that cause operations, the operations comprising:
generating a virtual user interface relative to a surface within a field of view of the imaging device, the virtual user interface comprising a digital marker corresponding to an appliance control function;
generating a control signal based on a physical user interaction relative to the digital marker.

2. The appliance computing device of claim 1, the operations comprising:
obtaining an image comprising a digital representation of the physical user interaction within the field of view of the imaging device; and
determining a spatial correlation of the digital marker to the digital representation.

3. The appliance computing device of claim 2, wherein determining the spatial correlation of the digital marker to the digital representation comprises:
segmenting the image into one or more parts corresponding to the digital marker; and
determining, at the one or more parts, an overlay of the digital representation of the physical user interaction to the digital marker.

4. The appliance computing device of claim 3, the operations comprising:
determining the physical user interaction relative to the digital marker based on the overlay of the digital representation of the physical user interaction to the digital marker.

5. The appliance computing device of claim 2, the operations comprising:
superimposing the digital marker relative to the surface.

6. The appliance computing device of claim 1, wherein the control signal corresponds to the appliance control function.

7. The appliance computing device of claim 6, the operations comprising:
transmitting the control signal to articulate an operational component corresponding to the appliance control function.

8. The appliance computing device of claim 1, the operations comprising:
projecting, toward the surface, the virtual user interface as a light-based representation perceptible to a user.

9. A method for operating an appliance, the method comprising:
generating a virtual user interface corresponding to a surface of the appliance within a field of view of an imaging device operably coupled to an appliance computing device, the virtual user interface comprising a digital marker corresponding to an appliance control function;
generating a control signal based on a physical user interaction relative to the digital marker; and
transmitting the control signal to articulate an operational component of the appliance, wherein articulation of the operational component corresponds to the appliance control function.

10. The method of claim 9, the method comprising:
obtaining, via the imaging device, an image comprising a digital representation of the physical user interaction within the field of view; and
determining a spatial correlation of the digital marker to the digital representation.

11. The method of claim 10, wherein determining the spatial correlation of the digital marker to the digital representation comprises:
segmenting the image into one or more parts corresponding to the digital marker; and
determining, at the one or more parts, an overlay of the digital representation of the physical user interaction to the digital marker.

12. The method of claim 11, the method comprising:
determining the physical user interaction relative to the digital marker based on the overlay of the digital representation of the physical user interaction to the digital marker.

13. The method of claim 9, the method comprising:
superimposing the digital marker relative to the surface.

14. The method of claim 9, the method comprising:
projecting, toward the surface, the virtual user interface as a light-based representation perceptible to a user.

15. An appliance, comprising:
a surface;
an operational component configured to perform a control function;
an imaging device configured with a field of view toward the surface; and
a computing device comprising a processor operably coupled to the imaging device, the processor configured to execute operations, the operations comprising:
generating a virtual user interface corresponding to the surface within the field of view of the imaging device, the virtual user interface comprising a digital marker corresponding to the control function;
generating a control signal based on a physical user interaction relative to the digital marker; and
transmitting the control signal to perform the control function at the operational component.

16. The appliance of claim 15, wherein the surface comprises a physical marker, and wherein the physical marker is uncoupled electrically to the computing device, and wherein the operations comprise superimposing the digital marker to the physical marker at the surface.

17. The appliance of claim 15, the operations comprising:
obtaining, via the imaging device, an image comprising a digital representation of the physical user interaction within the field of view of the imaging device; and
determining a spatial correlation of the digital marker to the digital representation.

18. The appliance of claim 17, wherein determining the spatial correlation of the digital marker to the digital representation comprises:
segmenting the image into one or more parts corresponding to the digital marker; and
determining, at the one or more parts, an overlay of the digital representation of the physical user interaction to the digital marker.

19. The appliance of claim 18, the operations comprising:
determining the physical user interaction relative to the digital marker based on the overlay of the digital representation of the physical user interaction to the digital marker.

20. The appliance of claim 17, wherein determining the spatial correlation of the digital marker to the digital representation comprises:
segmenting the image into one or more parts corresponding to the digital marker; and
determining, at the one or more parts, an overlay of the digital representation of the physical user interaction to the digital marker and a physical marker at the surface.
